(19) United States
(12) Patent Application Publication
(10) Pub. No.: US 2008/0174037 A1
(43) Pub. Date: Jul. 24, 2008

(54) Patterning method

(75) Inventor: Yu-Ho Chen, Fongshan City (TW)

Correspondence Address: RABIN & Berdo, PC, 1101 14TH STREET, NW, SUITE 500, WASHINGTON, DC, 20005, US

(73) Assignee: MICRO-STAR INT'L CO., LTD, Jung-He City (TW)

(21) Appl. No.: 11/654,503

(22) Filed: Jan. 18, 2007

(51) Int. Cl. B29C 59/02

(52) U.S. Cl. 264/40.1; 156/62; 156/245

(57) ABSTRACT

A patterning method is provided. A predetermined pattern is drawn on a substrate, and a plurality of decorative parts is distributed and fixed on the predetermined pattern through a bonding process. In addition, a pattern obtained by distributing the plurality of decorative parts assumes a three-dimensional pattern model on the substrate.

### BACKGROUND OF THE INVENTION

1. Field of Invention

The present invention relates to a frame patterning method, and more particularly, to a patterning method of forming a three-dimensional pattern on a case of an electronic device.

2. Related Art

Technical products, such as mobile phones, PDAs, multimedia players (PMP, MP3 Player), hand-held computers (Hand-held PC, UMPC), or notebook computers, have a large memory capacity and a strong calculation capability, which are used by the user for storing or processing data, and have gradually become popular private handheld tools. As the continuous development and progress of the technology, the technical products with smaller volume, larger memory capacity, and higher calculation speed have gradually brought forth new products, which have various functions to cater to different requirements of the users. However, no matter for the PDAs, the Hand-held computers or the notebook computers, due to the restriction in internal electronic parts and elements and in the volume, the cases are generally rectangular-shaped made of a plastic material or metal material, and thus the mass-produced electronic data processing devices assume to be simple and dull in external appearance, which cannot meet the consumers' requirements for products of personality and diversification.

In addition, some manufacturer utilizes the coating technique to develop cases with different colors or mirror-coatings. For example, U.S. Pat. No. 6,327,142 and U.S. Pat. No. 6,775,130 disclose a case wrapped with materials such as leather, which are intended to satisfy the consumers' requirements for the external appearance of the technical products. However, the simple changes in coating or materials seem to be still very dull, and thus Intel Corporation provides an Interchangeability, wherein a Customizable notebook computer Panel is provided for the notebook computer manufacturers to change notebook computer panels(3w.intel.com/cd/channel/reseller/asmo-na/eng/products/mobile/mprod/bb/271562.ht m). A recess is designed on a case of the notebook computer, for disposing a panel drawn with a desirable pattern or image, which not only adds visual funs for the dull external appearance of the notebook computer, but also satisfies the consumers' requirements for products of personality and diversification.

Customizable notebook computer panel does satisfy the consumers' requirements for the personality. However, the changeable panel only assumes a plane visual sense, but cannot assume the texture of technical products. Therefore, the external texture of the current technical products cannot satisfy the consumer group with high texture requirements.

### SUMMARY OF THE INVENTION

In order to solve the problem of the simple and dull external appearance of the current technical products, cases with different colors or mirror coatings, and cases with changeable panels are provided, but which still assume a plane visual sense, such that they are not the optimal designs for the case model of the technical products, considering the presentation of texture of the technical products. In view of this, the present invention provides a patterning method for presenting a three-dimensional pattern with high texture sense on a case of a technical product.

The patterning method disclosed in the present invention is applicable to a case of a technical product, wherein a plurality of decorative parts is distributed on the case to form a pattern, and the patterning method comprises the following steps:

drawing a predetermined pattern such as a graphic, a symbol, or a character on a substrate through a cartographic process;

distributing a plurality of decorative parts on the substrate through a bonding process; and

the plurality of decorative parts distributed on the substrate forming a three-dimensional pattern model.

Furthermore, a case of a notebook computer to which the patterning method disclosed in the present invention applied comprises a housing with a plurality of granular decorative parts (such as diamonds) disposed on the surface of the case, wherein the plurality of granular decorative parts forms a pattern such as a graphic, a symbol, or a character, such that the surface of the notebook computer case has the pattern formed by distributing the decorative parts such as diamonds.

According to the patterning method disclosed in the present invention, the cartographic process and the bonding process both can be achieved through automatic machines, and diamonds are inlaid on the case of the technical product through an automatic or semi-automatic process, and the plurality of diamonds is distributed to form a three-dimensional pattern, such as a graphic, a symbol, or a character, so as to provide a visual effect with a high texture sense for the simple and dull technical products, and thereby increasing the additional value of the technical products besides the functional performances.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus is not limitative of the present invention, and wherein:

FIG. 1 is a schematic flow chart of a first embodiment of the present invention;

FIGS. 2A to 2C are schematic views of specific steps for implementing the first embodiment of the present invention;

FIG. 3 is a view of an application example of a structure of a second embodiment of the present invention;

FIG. 4 is a schematic flow chart of the second embodiment of the present invention; and

FIGS. 5A and 5B are schematic views of specific steps for implementing a third embodiment of the present invention.

### DETAILED DESCRIPTION OF THE INVENTION

In the patterning method according to the present invention, a plurality of decorative parts is used to form a three-dimensional pattern on a case of a technical product. The technical product includes but not limited to electronic data processing device, such as mobile phones, PDAs, multimedia players (PMP, MP3 Player), hand-held computers (Hand-held PC, UMPC) or notebook computers. The material of the case includes but not limited to plastic, alloy, or carbon-fiber materials, such as polymer materials (Acrylonitrile Butadiene Styrene (ABS)), a Magnesium-Aluminum alloy material, a Titanium alloy material or a carbon-fiber material. The decorative part includes but not limited to decoration materials that are identical to or different from the material of the case, such as jewels, diamonds, heavy metals, alloys, crystals, glasses, acrylic or junipers, the decorative parts include but not limited to geometric shapes, such as irregular or regular particle shapes, sphere shapes, block shapes, or stripe shapes. In the following specific embodiments of the present invention, a notebook computer with a case made of Mg-Al alloy and inlaid with diamonds is taken as a specific embodiment for the present invention.

The patterning method disclosed in the present invention at least includes steps of a cartographic process and a bonding process. The cartographic process includes forming a predetermined pattern on a substrate through the processing methods of laser engraving, transfer printing, drilling and milling, etching, computer numerical control (CNC) machine, or stamping. The bonding process includes fixing the decorative parts on the substrate through the processing methods such as adhesive, surface mount technology (SMT), mosaicking, or metallurgical bonding. However, in the specific embodiment, the implementation varies due to different selections in materials of the substrate and the decorative parts, and different processing methods, wherein other steps are added, or the implementation is performed in a full-automatic or semi-automatic manner.

### The First Embodiment

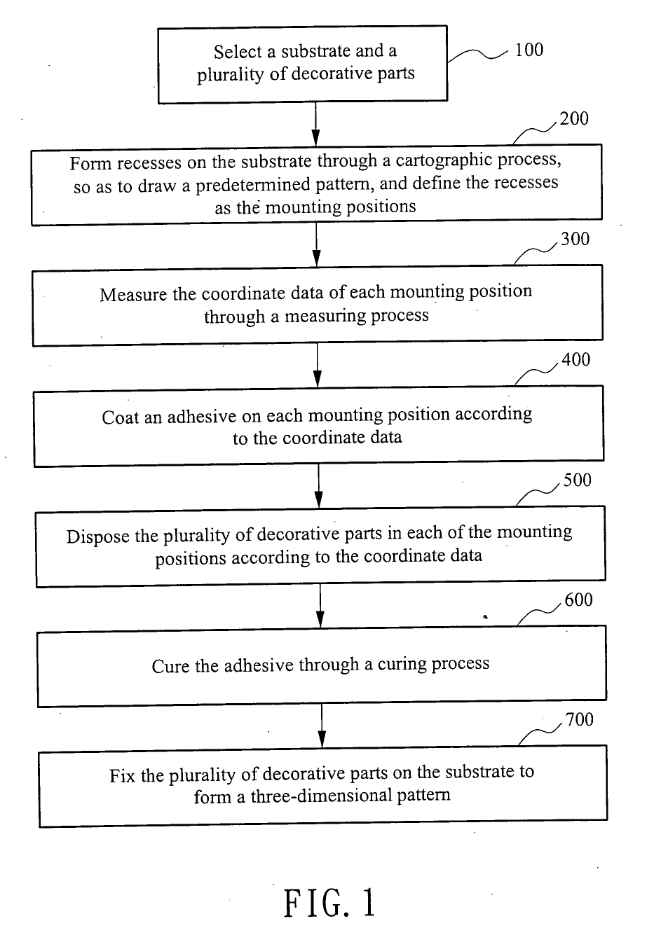

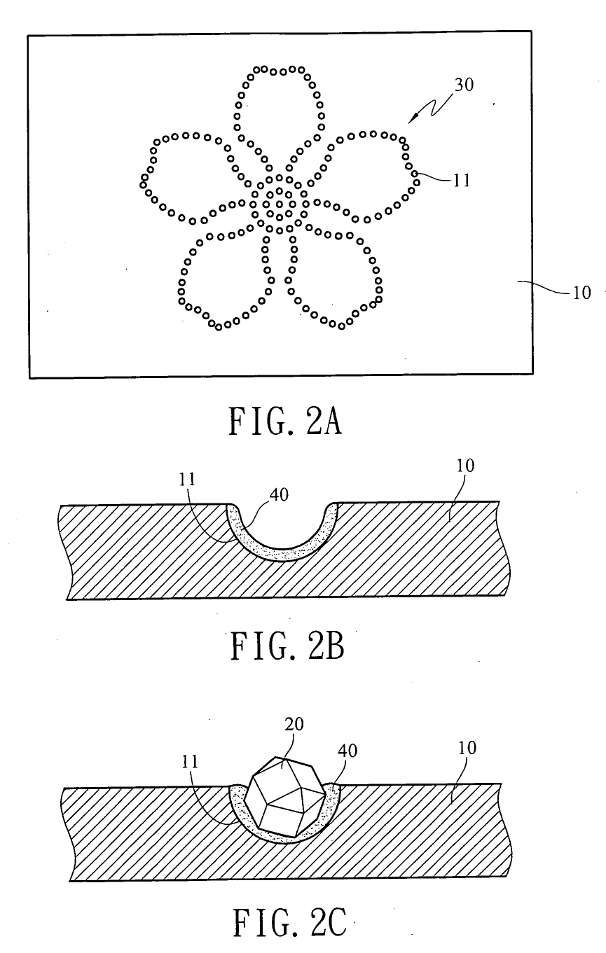

As shown in FIG. 1, in the patterning method according to a first embodiment of the present invention, a substrate 10 and a plurality of decorative parts 20 is selected first (Step 100), wherein the substrate 10 is made of an Mg—Al alloy material, and the plurality of decorative parts 20 is diamonds. A plurality of recess 11 is formed on a surface of the substrate 10 through a cartographic process of laser engraving, so as to draw a predetermined pattern 30 (Step 200, referring to FIG. 2A), the predetermined pattern may be a graphic, a symbol or a character, for example, a flower pattern, as shown in FIG. 2A, and each recess 11 is used to dispose one decorative part 20 and is defined as a mounting position. The coordinate data of each mounting position is measured through a measuring process (Step 300), wherein the measuring process is calculating by using a coordinate measuring machine (CMM). Through the bonding process of adhesive, an adhesive 40 is coated on each mounting position by an automatic dispenser according to the coordinate data obtained in Step 300 (Step 400, referring to FIG. 2B). According to the coordinate data obtained in Step 300, each of the decorative parts 20 is adsorbed by an automatic inserting machine and disposed in each of the mounting positions (Step 500). The adhesive is cured through a curing process (Step 600), wherein the curing process may be natural curing or drying curing, such that each of the decorative parts 20 is fixed in each recess 11 of the substrate 10, and each of the decorative parts 20 protrudes from the surface of the substrate 10. Finally, a three-dimensional pattern 31 is formed on the substrate 10 through each of the decorative parts 20 (Step 700, referring to FIG. 2C).

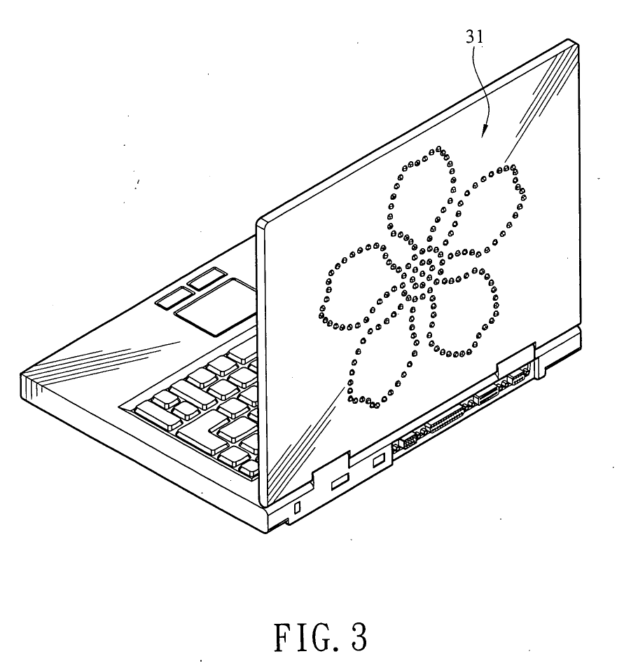

The substrate 10 decorated with decorative parts 20 is used as a case of a notebook computer (as shown in FIG. 3), the decorative parts 20 are diamonds distributed as a flower pattern, which gives a three-dimensional visual effect with a high texture sense, thereby enhancing the product value of the notebook computer.

In addition, the laser engraving process employs a laser engraving machine to draw the predetermined pattern 30 through a semi-automatic process operated by a craftsman, and thus the predetermined pattern 30 formed each time slightly varies from each other, which is suitable for customizing process. If it is intended to manufacturing through mass production, patterns, symbols or characters are inkjet printed on the substrate 10 through a cartographic process such as transfer printing, and then processed through laser engraving, such as drilling and milling by a semi-automatic machine such as a milling machine, or through a chemical etching process, which all fall within the scope of the cartographic process of the first embodiment.

### The Second Embodiment

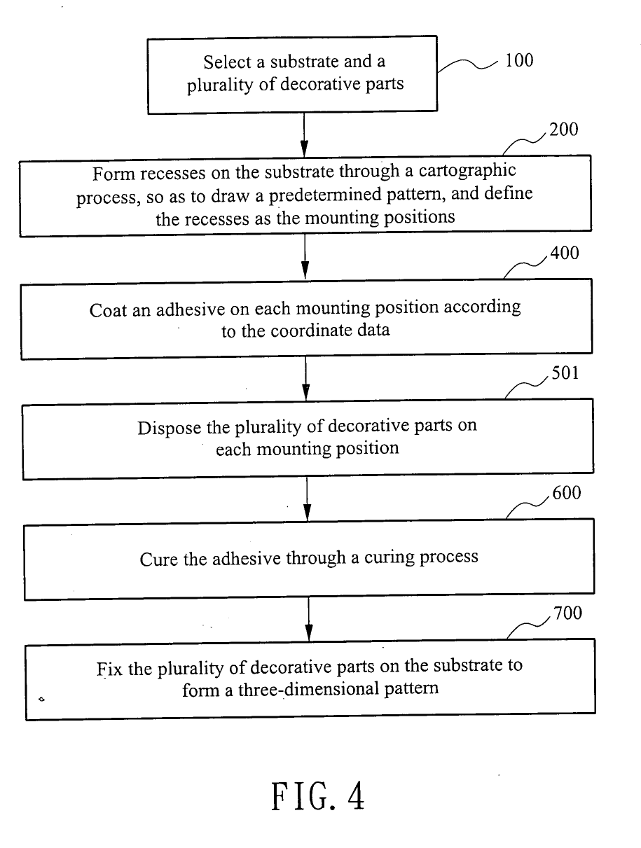

As shown in FIG. 4, the patterning method according to a second embodiment of the present invention includes the following steps. First, a substrate 10 and a plurality of decorative parts 20 is selected (Step 100), wherein the substrate 10 is made of an Mg-Al alloy material, and the plurality of decorative parts 20 is diamonds. A plurality of recesses 11 is formed on an upper surface of the substrate 10 through a cartographic process of CNC, so as to draw a predetermined pattern 30 (Step 200), wherein the cartographic process of CNC includes steps of drawing a digital graphic file via a computer in advance, and inputting the digital graphic file to the CNC, such that the CNC fabricates the recesses 11 on the substrate 10 through a work piece such as a milling cutter according to the data document of digital graphic file, and each of the recesses 11 is used to dispose a decorative part 20 and is defined as a mounting position. Through a bonding process of adhesive, an adhesive 40 is coated on each of the mounting positions by an automatic dispenser according to the digital graphic file (Step 400). According to the data document of digital graphic file, each of the decorative parts 20 is adsorbed by an automatic inserting machine and disposed in each of the mounting-positions (Step 501). The adhesive is cured through a curing process (Step 600), wherein the curing process may be natural curing or drying curing, such that each of the decorative parts 20 is fixed in each recess 11 of the substrate 10, and each of the decorative parts 20 protrudes from the surface of the substrate 10. Finally, a three-dimensional pattern is formed on the substrate 10 through each of the decorative parts 20 (Step 700).

In the patterning method according to the second embodiment of the present invention, through drawing a digital graphic file via a computer in advance, a coordinate of each mounting position is determined once it is drawn via the computer, such that the measuring process in the first embodiment can be omitted. By using the full automatic process, the processing speed is accelerated. Furthermore, a mold is also fabricated through a digital graphic file by using a stamping device such as a punch, and all the recesses 11 can be formed through one stamping operation, which also further reduces the required fabricating time.

In addition, if the substrate 10 is made of a polymer material such as ABS with a plastic injection molding machine, similarly, an injection molding module also can be fabricated through the digital graphic file, and the recesses 11 are integrally formed on the substrate 10 made of the polymer material. Therefore, the processing methods such as CNC, stamping device, or plastic injection molding machine, with which the data document of the mounting positions can be achieved through the digital graphic file, all belong to the cartographic process of the second embodiment of the present invention.

### The Third Embodiment

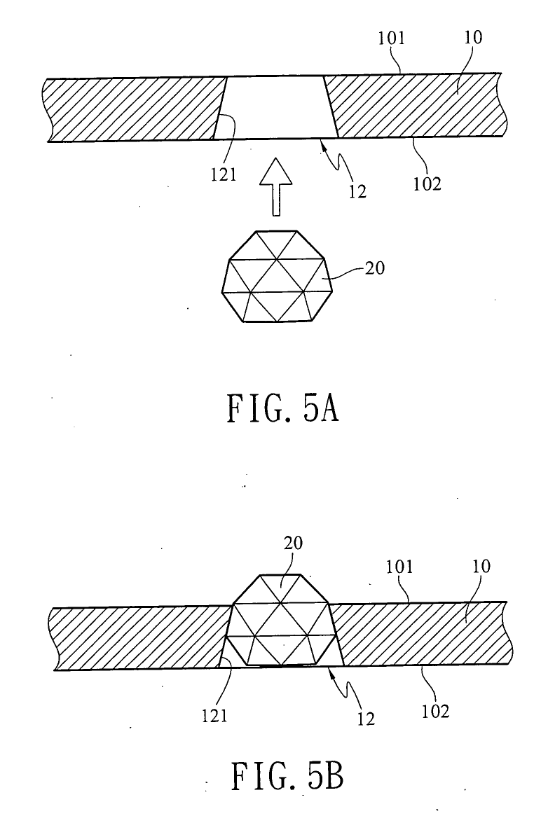

As shown in FIGS. 5A, 5B, in the patterning method according to a third embodiment of the present invention, the processing steps are the same as those of the first embodiment or the second embodiment, that is, the cartographic processes such as laser engraving, semi-automatic mechanical drilling and milling, CNC, stamping device, or plastic injection molding machine are employed. As for the cartographic process used in the third embodiment of the present invention, a predetermined pattern 30 is drawn through forming through holes 12 on the substrate 10, an adhesive surface 121 is formed on the inner wall of the through hole 12, and depending upon the characteristics of different materials of the substrate 10 and the decorative parts 20, different bonding processes are employed. For example, the bonding process of adhesive is coating the adhesive 40 on the adhesive surface 121, as described in the first and second embodiments. Or, the through hole 12 is fabricated as a hole with unequal diameters, the substrate 10 takes the surface corresponding to a small aperture of the through hole 12 as an outer surface 101, and takes the surface corresponding to the large aperture of the through hole 12 as an inner surface 102, and the size of the decorative part 20 is slightly larger than that of the through hole 12. The machine such as the automatic inserting machine is used to adsorb the decorative part 20 to inlay it in the through hole 12 from the inner surface 102 of the substrate 10, such that the decorative part 20 and the through hole 12 are firmly engaged, and the decorative parts 20 protrude form the outer surface 101, thereby forming a three-dimensional pattern 31.

Furthermore, if the substrate 10 is made of an Mg-Al alloy material, and the decorative parts 20 are also made of the Mg-Al alloy material or another metal material (such as, Ti alloy material), after the decorative parts 20 are inlaid in the through holes 12, the bonding process of metallurgical bonding is utilized, wherein a high temperature is applied, such that a diffusion or an alloy process occurs between the substrate 10 and the decorative parts 20, which similarly causes the decorative parts 20 to be fixed within the through holes 12 of the substrate 10.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A patterning method, comprising:
selecting a substrate and a plurality of decorative parts;
forming a plurality of mounting positions through a cartographic process, so as to draw a predetermined pattern;
fixing the plurality of decorative parts on the mounting positions through a bonding process; and
forming a three-dimensional pattern by the plurality of decorative parts on the substrate.

2. The patterning method as claimed in claim 1, wherein the cartographic process is a computer numerical control (CNC) processing method.

3. The patterning method as claimed in claim 2, wherein the CNC processing method comprises drawing a digital graphic file via a computer, inputting the digital graphic file to a CNC machine, and thereby forming the plurality of mounting positions on the substrate.

4. The patterning method as claimed in claim 1, wherein the cartographic process is a stamping device processing method.

5. The patterning method as claimed in claim 4, wherein the stamping device processing method comprises drawing a digital graphic file via a computer, fabricating a mold according to the digital graphic file, and forming the plurality of mounting positions by stamping once.

6. The patterning method as claimed in claim 1, wherein the cartographic process is a plastic injection molding processing method.

7. The patterning method as claimed in claim 6, wherein the plastic injection molding processing method comprises drawing a digital graphic file via a computer, fabricating an injection molding module according to the digital graphic file, thereby integrally forming the plurality of mounting positions.

8. The patterning method as claimed in claim 1, wherein the bonding process is an adhesive processing method, and comprises:
coating an adhesive on the plurality of mounting positions;
disposing the plurality of decorative parts on the plurality of mounting positions; and
curing the adhesive through a curing process.

9. The patterning method as claimed in claim 1, wherein the bonding process is a mosaicking processing method, and the decorative parts are inlaid in the mounting positions to be firmly engaged therein.

10. The patterning method as claimed in claim 1, wherein the bonding process is a metallurgical bonding processing method, and the decorative parts are inlaid in the mounting positions and applied with a high temperature, such that an alloy process occurs between the substrate and the decorative parts.

11. A patterning method, comprising:
selecting a substrate and a plurality of decorative parts;
forming a plurality of mounting positions on the substrate through a cartographic process, so as to draw a predetermined pattern;
measuring coordinate data of the plurality of mounting positions through a measuring process;
fixing the plurality of decorative parts at the mounting positions through a bonding process according to the coordinate data; and
forming a three-dimensional pattern by the plurality of decorative parts on the substrate.

12. The patterning method as claimed in claim 11, wherein the cartographic process is a laser engraving processing method.

13. The patterning method as claimed in claim 11, wherein the cartographic process is a chemical etching processing method.

14. The patterning method as claimed in claim 11, wherein the measuring process is using a coordinate measuring machine (CMM) to calculate the coordinate data of each of the mounting positions.

15. The patterning method as claimed in claim 11, wherein the bonding process is an adhesive processing method, and comprises:
coating an adhesive on the plurality of mounting positions;
disposing the plurality of decorative parts at the plurality of mounting positions; and
curing the adhesive through a curing process.

16. The patterning method as claimed in claim 11, wherein the bonding process is a mosaicking processing method, and the decorative parts are inlaid in the mounting positions to be firmly engaged therein.

17. The patterning method as claimed in claim 11, wherein the bonding process is a metallurgical bonding processing method, and the decorative parts are inlaid in the mounting positions and applied with a high temperature, such that an alloy process occurs between the substrate and the decorative parts.

18. A notebook housing manufactured through the method as claimed in claim 1.
